(19) United States
(12) Patent Application Publication
(10) Pub. No.: US 2011/0164858 A1
(43) Pub. Date: Jul. 7, 2011

(54) VIDEO DATA CREATION DEVICE, VIDEO DATA CREATION METHOD, VIDEO DATA CREATION PROGRAM, RECORDING MEDIUM THEREOF, AND INTEGRATED CIRCUIT

(76) Inventors: Kinichi Motosaka, Osaka (JP); Ryohei Wakai, Osaka (JP); Yuzo Kawamura, Osaka (JP); Koji Hamasaki, Hyogo (JP)

(21) Appl. No.: 13/119,805

(22) PCT Filed: Nov. 10, 2009
(86) PCT No.: PCT/JP2009/005975

§ 371 Date: Mar. 18, 2011

(30) Foreign Application Priority Data
Nov. 13, 2008 (JP) 2008-290536

(51) Int. Cl. H04N 5/93

(52) U.S. Cl. 386/278; 386/E05.001

(57) ABSTRACT

To aim to provide a video data creating apparatus for easily creating multi-angle video data for multi-angle playback. without performing editing that requires a huge amount of effort by handling a plurality of pieces of video data simultaneously, when multi-angle video for multi-angle playback is created. The video data creating apparatus of the present invention detects a set of blocks for multi-angle playback, based on video information included in video data and creates playback path information such that the detected set of blocks are video data for multi-angle playback.

### TECHNICAL FIELD

The present invention relates to creating multi-angle video data for multi-angle playback.

### BACKGROUND ART

In recent years, common people have been able to easily take a video due to spread of digital video cameras. Furthermore, video functions have been added to devices such as mobile phones and digital still cameras, and accordingly devices that can take a video are more and more familiar.

At events such as sports days and wedding ceremonies, a number of attendees bring their own digital video cameras or digital still cameras, and each of the attendees captures a video. They take videos at the same time and place from different angles. Video data of the videos taken at the same time and place from different angles in this way is, for example, used to create multi-angle video data for multi-angle playback.

Multi-angle video data for multi-angle playback includes a certain playback section where an angle can be switched to another angle during playback on a playback device, for example, by a button operation, and viewed from different angles.

Patent Document 1 discloses a technology for creating multi-angle video data for multi-angle playback.

### [Citation List]

### [Patent Literature]

### [Patent Literature 1]

Japanese Patent Application Publication No. 2005-107968

### SUMMARY OF INVENTION

### [Technical Problem]

However, the above-mentioned conventional technology is designed on the assumption that a plurality of pieces of video data are transmitted mainly by a transport stream and recorded as video data for multi-angle playback. According to such a technology, multi-angle video data for multi-angle playback is created all at once from the plurality of pieces of video data. Accordingly, a plurality of pieces of video data captured by a number of people are collected and edited all at once, and as a result, a large capacity recording medium is required to store a large amount of data. Also, since a necessary part must be searched for from the large amount of collected data for editing, creating multi-angle video data for multi-angle playback requires a huge amount of effort.

The present invention aims to provide a video data creating apparatus for easily creating multi-angle video data for multi-angle playback without performing editing that requires a huge amount of effort.

### [Solution to Problem]

In order to solve the above problem, a video data creating apparatus of the present invention for creating third video data, based on first video data and second video data, the first video data being stored in a first recording medium and including (i) a first video stream including blocks, (ii) first playback path information indicating a playback path of the first video stream, and (iii) first video information including pieces of capturing information, which are related to respective blocks of the first video stream, the capturing information including one or more elements including captured time and date information indicating when a video included in each block was captured, the second video data being stored in a second recording medium that is different from the first recording medium and including (i) a second video stream including blocks, (ii) second playback information indicating a playback path of the second video stream, and (iii) second video information including pieces of the capturing information, which are related to respective blocks of the second video stream, the video data creating apparatus comprising; an acquisition unit operable to acquire the first video data, the second video data and comparison reference information indicating one of the elements included in the capturing information that is to be a reference for comparing the blocks of the first video stream with the blocks of the second video stream; a detecting unit operable to detect, among the blocks of the first video stream and the blocks of the second video stream, a set of blocks that match in the element indicated by the comparison reference information among the elements included in the pieces of the capturing information related to respective blocks; and a creating unit operable, when the detecting unit detects the set of blocks, to create the third video data, such that the set of blocks synchronize, the third video data including (i) playback path information indicating a playback path of the set of blocks detected by the detecting unit, (ii) the detected set of blocks, and (iii) the first video information of the first video stream.

### [Advantageous Effects of Invention]

According to the above video data creating apparatus, blocks for multi-angle playback are detected from the video streams by comparison of the capturing information included in the video information. Accordingly, it is possible to easily create multi-angle video data for multi-angle playback without performing editing that requires a huge amount of effort.

Here, the above video data creating apparatus may further comprise a writing unit operable to overwrite the first recording medium with the third video data.

By overwriting with the created video data, multi-angle video data for multi-angle playback is finally left in the first recording medium, after the matching blocks are extracted from a plurality of video data captured by a number of people based on the comparison reference information set by a person who first wrote his/her video data in the first recording medium. For example, the multi-angle video data is created after the first recording medium is handed among people who captured videos at the same sports day and a plurality of pieces of video data captured by the people are appended to the recording medium.

Here, each of the first playback path information and the second playback path information may include (i) a video stream identifier indicating a video stream that is to be played pack in a playback path indicated by the playback path information and (ii) a multi stream flag indicating whether the playback path includes more than one video stream that is to be played back, and the creating unit creates playback path information included in the third video by (i) adding the video stream identifier indicating the second video stream to the playback path information indicating a playback path that includes blocks included in the set of blocks detected by the detecting unit, among the playback paths indicated by respective pieces of the playback path information included in the first video data and the second video data, and (ii) setting the multi stream flag included in the playback path information to be on.

By modifying the playback path information included in the video data stored in the first recording medium, a piece of information is added to the playback path information. The piece of information indicates a video stream to be played back in the playback path. Accordingly, it is not necessary to modify a video stream per se to create multi-angle video data for multi-angle playback. The comparison reference information may indicate a plurality of elements included in the capturing information, and when the set of blocks match in all of the plurality of elements that are included in the capturing information and indicated by the comparison reference information among the elements related to respective blocks included in the set of blocks, the detecting unit detects the set of blocks.

Since the more than one element included in the capturing information are compared to judge whether blocks match, it is possible to detect blocks that are more suitable for multi-angle playback. This is based on an idea that, for multi-angle playback, scenes in which the same person is captured at the same time is more suitable than scenes in which different people are captured at the same time.

Here, when the comparison reference information indicates the plurality of elements included in the capturing information and the elements that are included in the capturing information and indicated by the comparison reference information include the captured time and date information, the detecting unit may judge whether the set of blocks match with use of time and date information preferentially.

By judging whether the blocks match by giving preference to captured time and date, it is possible to detect blocks that also match in another element included in the capturing information among video streams included in different pieces of video data captured at the same time. Accordingly, it is possible to create multi-angle video whose blocks have synchronized captured time and date.

Here, the capturing information may include captured location information as an element, the captured location information indicating where a video included in the block was captured, and when the elements included in the capturing information related to the respective blocks of the set of blocks match in the captured location information, the detecting unit detects the set of blocks.

By judging whether blocks match by comparing captured locations, blocks in which the same location was captured are detected. Accordingly, it is possible to create multi-angle video in which scenes captured at the same location at different times can be switched.

Here, the capturing information may include captured person information as an element, the captured person information indicating a person captured in a video included in the block, and

when elements included in the capturing information related to the respective blocks of the set of blocks match in the captured person information, the detecting unit detects the set of blocks.

By judging whether blocks match by comparing the captured people, blocks in which the same person was captured are detected. Accordingly, it is possible to create multi-angle video in which scenes in which a specified person was captured at different location at different time can be switched.

Here, the video data creating apparatus may further include a writing unit operable to write the third video data and the comparison reference information in a third recording medium that is different from the first recording medium.

For example, a recording medium in which video data is stored is handed among people who captured videos at the same sports day so as to create multi-angle video data for multi-angle playback based on video data captured by each of the people. In such a case, even if the first recording medium is not rewritable, it is possible to create multi-angle video data as follows. Multi-angle video data is created based on comparison reference information set by a person who first stored his/her video data in the first recording medium. The created video data and the comparison reference information are stored in a third recording medium that is different from the first recording medium. The third recording medium is handed among the people.

### BRIEF DESCRIPTION OF DRAWINGS

FIG. 1 shows a usage example of a video data creating apparatus pertaining to an embodiment 1.

FIG. 2 shows a structure of the video data creating apparatus pertaining to the embodiment 1.

FIG. 3 shows a relationship between video streams and blocks pertaining to the embodiment 1.

FIG. 4 shows a structure of playback path information pertaining to the embodiment 1.

FIG. 5 shows a structure of video information pertaining to the embodiment 1.

FIG. 6 explains a creating process of the playback path information pertaining to the embodiment 1.

FIG. 7 shows a structure of the playback path information created by the video data creating apparatus pertaining to the embodiment 1.

FIG. 8 is a flowchart showing an operation of a video data creating process pertaining to the embodiment 1.

FIG. 9 is a flowchart showing an operation of a video information comparing process pertaining to the embodiment 1.

FIG. 10 is a flowchart showing an operation of a playback path information creating process pertaining to the embodiment 1.

FIG. 11 shows a structure of a video data creating apparatus pertaining to an embodiment 2.

FIG. 12 shows a structure of image information pertaining to the embodiment 2.

FIG. 13 is a flowchart showing an operation of an image stream creating process pertaining to the embodiment 2.

### DESCRIPTION OF EMBODIMENTS

### First Embodiment

The present embodiment explains a video data creating apparatus that operates as follows. The video data creating apparatus reads video data stored in an optical disc and video data stored in a memory card to create multi-angle video data for multi-angle playback. By deleting the video data stored in the optical disc and writing the created multi-angle video data for multi-angle playback in the optical disc, the video data creating apparatus appends the video data stored in the memory card to the video data stored in the optical disc.

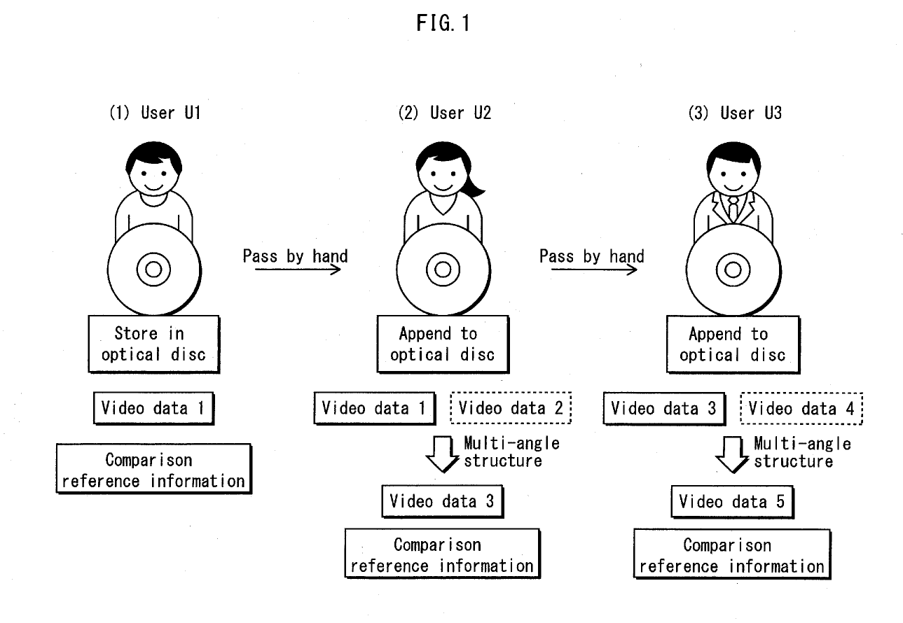

The following explains an example of situation for using the video data creating apparatus of the present embodiment, using FIG. 1.

The video data creating apparatus is expected to be used for creating multi-angle video data for multi-angle playback from a plurality of pieces of video data captured by a plurality of users, as follows. At events such as sports days, a plurality of users capture videos at the same time and place from different angles. One of the users stores a piece of video data that he/she captured in an optical disc, and hands the optical disc to another user who possesses the video data creating apparatus. The user who has received the optical disc appends a piece of video data that he/she captured to the video data stored in the optical disc.

FIG. 1 explains usage situation of the video data creating apparatus. Users

U1, U2 and U3 possess video data 1, video data 2 and video data 4, respectively. Each of the users captured a video mainly of his/her child at the same sports day.

(1) First, the user U1 writes in an optical disc, the video data 1 that he/she captured and comparison reference information indicating conditions under which a multi-angle video is to be created, and then hands the optical disc to the user U2. Here, the comparison reference information indicates a feature to be focused on when multi-angle video is created, among features of the captured video such as time and date, location and person. For example, in a case of capturing a video of sports day, the user U1 sets beforehand a condition that a name of a captured person is a name of a child of the user U1 as the comparison reference information. It is then possible to extract scenes in which the child of the user U1 is on from a plurality of pieces of video data captured by others so as to create a multi-angle video, as described later.

(2) The user U2 who has received the optical disc creates video data 3 that is multi-angle video data for multi-angle playback, as follows. The user U2 uses the video data creating apparatus that the user U2 possesses, and reads, based on the comparison reference information stored in the optical disc, the video data 1 stored in the optical disc and the video data 2 that the user U2 captured. The user U2 creates the video data 3 composed of the video data 1 and a part of the video data 2. The user U2 writes the created video data 3 in the optical disc and hands the optical disc to the user U3.

(3) The user U3 who has received the optical disc creates video data 5 that is multi-angle video data for multi-angle playback in the same way, as follows. The user U3 uses the video data creating apparatus that the user U3 possesses, and reads, based on the comparison reference information stored in the optical disc, the video data 3 stored in the optical disc and the video data 4 that the user U3 captured. The user U3 creates the video data 5 composed of the video data 3 and a part of the video data 4.

The above process is repeated. That is, multi-angle video data for multi-angle playback is repeatedly created from the video data stored in the optical disc and video data possessed by an owner of the video data creating apparatus. Then the optical disc storing therein the created video data is repeatedly handed to others. When the optical disc is finally returned to the user U1, the user U1 obtains a multi-angle video for multi-angle playback, which is composed of scenes extracted from the plurality of pieces of video data of the videos captured by a number of people, based on the comparison reference information.

That is, the user U1 stores in the optical disc, the video data that he/she captured and the comparison reference information indicating that the name of the captured person is the name of the child of the user U1. The optical disc is repeatedly handed to the user U2, U3 and so on such that multi-angle video data for multi-angle playback is created from video data captured by each user, based on the comparison reference information. As a result, the user U1 can obtain multi-angle video data for multi-angle playback that enables to view the child of the user U1 from different angles.

### <Structure>

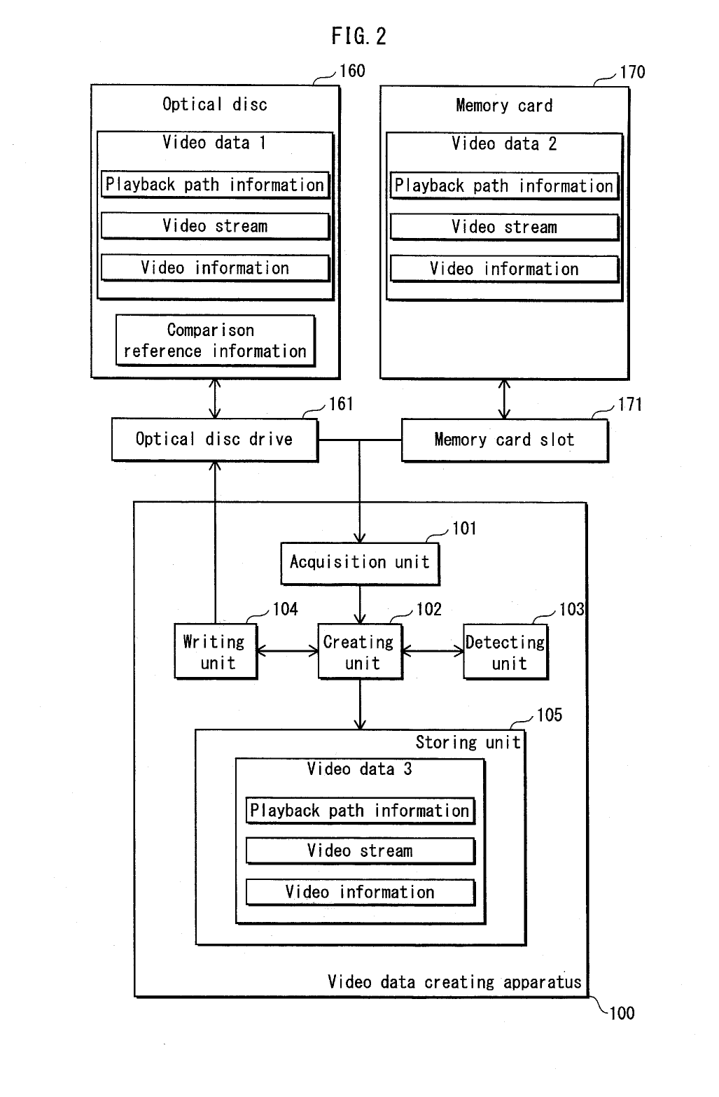

The following explains a structure of the video data creating apparatus of the present embodiment, using FIG. 2.

A video data creating apparatus 100 of the present embodiment acquires video data 1 and comparison reference information each stored in an optical disc 160 by an optical disc drive 161 and video data 2 stored in a memory card 170 by a memory card slot 171. The video data creating apparatus 100 then creates video data 3 that is multi-angle video data for multi-angle playback from the video data 1 and the video data 2, based on the comparison reference information. Also, the video data creating apparatus 100 overwrites the optical disc 160 with the created video data 3 by the optical disc drive 161. Here, the term “overwrite” means deleting the video data 1 stored in the optical disc 160 and writing the video data 3 in the optical disc. Data other than the video data 1 in the optical disc 160, that is, the comparison reference information is not modified.

The video data creating apparatus 100 includes an acquisition unit 101, a creating unit 102, a detecting unit 103, a storing unit 105 and a writing unit 104.

The acquisition unit 101 acquires the video data 1 and the comparison reference information each stored in the optical disc 160 by the optical disc drive 161 and the video data 2 stored in the memory card 170 by the memory card slot 171. The acquisition unit 101 outputs the acquired video data 1, video data 2 and comparison reference information to the creating unit 102.

The creating unit 102 creates the video data 3 that is multi-angle video data for multi-angle playback, based on the video data 1, the video data 2 and the comparison reference information each acquired from the acquisition unit 101. The creating unit 102 accesses the storing unit 105 to store the created video data 3 and data that is used while the video data 3 is being created. The creating unit 102 instructs the detecting unit 103 to detect a part to be used for multi-angle playback in each of the video data 1 and the video data 2, based on the comparison reference information. The creating unit 102 then creates the video data 3, based on a result detected by the detecting unit 103. When creating the video data 3 is completed, the creating unit 102 instructs the writing unit 104 to write the created video data 3 in the optical disc 160.

The detecting unit 103 receives the instruction from the creating unit 102 and compares a video stream included in the video data 1 with a video stream included in the video data 2, based on the comparison reference information. The detecting unit 103 then detects a set of blocks that matches in an element included in the capturing information and indicated by the comparison reference information, among blocks that constitute the respective video streams.

The storing unit 105 is a recording medium that stores therein the video data 3 created by the creating unit 102 and the data that is used while the video data 3 is being created.

The writing unit 104 receives the instruction from the creating unit 102. The writing unit 104 then overwrites the optical disc 160 with the video data 3 created by the creating unit 102, by the optical disc drive 161.

### <Video Data>

The following explains a structure of video data handled by the video data creating apparatus 100.

Video data is composed of at least one piece of playback path information, at least one video stream and at least one piece of video information related to a corresponding video stream.
Video Stream

The video stream is an entity of data that includes a captured video. The video stream includes a PTS (Presentation Time Stamp) that indicates a position on the video stream. A section of the video stream, which corresponds to each PTS, is called a block. The video stream is identified by a video stream identifier. The video stream identifier is, for example, a name of a file in which the video stream is stored.

The video data 1 includes a single video stream, and has a video stream identifier ST1 that indicates the single video stream.

The video data 2 includes a single video stream, and has a video stream identifier ST2 that indicates the single video stream.

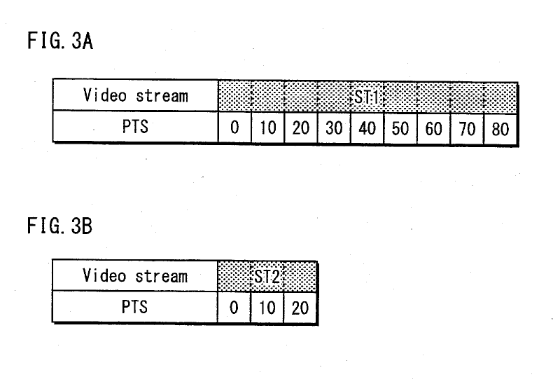

FIGS. 3A and 3B show respective examples of the video stream indicated by the video stream identifier ST1 that is included in the video data 1 and the video stream indicated by the video stream identifier ST2 that is included in the video data 2.

As FIG. 3A shows, the video stream indicated by the video stream identifier ST1 includes nine blocks corresponding to respective PTSs from 0 to 80.

As FIG. 3B shows, the video stream indicated by the video stream identifier ST2 includes three blocks corresponding to respective PTSs from 0 to 20.

In the following explanation, as long as there is no confusion, a video stream indicated by a video stream identifier ST is simply referred to as a video stream ST.
Playback Path Information

Playback path information indicates a path for playing back a video stream. The playback path information includes (i) a video stream identifier that indicates a video stream to be played back, (ii) a playback beginning PTS and playback end PTS of the video stream to be played back, and (iii) a multi-angle flag that indicates whether it is possible, in a section indicated by the playback beginning PTS and the playback end PTS each of the video stream to be played back, to perform multi-angle playback.

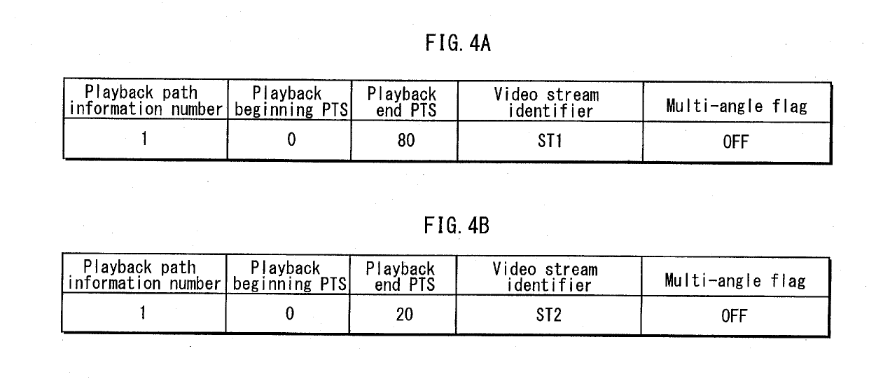

FIGS. 4A and 4B show respective examples of the two pieces of playback path information included in the video data 1 and the video data 2.

As FIG. 4A shows, the video data 1 includes a single piece of playback path information whose playback path information number is 1. The playback path information indicates an entire range of the video stream ST1. That is, the playback path information indicates that a section to be played back is in a range from the playback beginning PTS 0 to the playback end PTS 80. Furthermore, since a multi-angle flag of the playback path information is OFF, it is indicated that multi-angle playback is impossible.

As FIG. 4B shows, the video data 2 includes a single piece of playback path information whose playback path information number is 1. The playback path information indicates an entire range of the video stream ST2. That is, the playback path information indicates that a section to be played back is a range from the playback beginning PTS 0 to the playback end PTS 20. Furthermore, since a multi-angle flag of the playback path information is OFF, it is indicated that it is impossible to perform multi-angle playback.
Video Information

A piece of the video information is related to a video stream. The video information indicates capturing information of a video included in blocks that constitute the video stream, in units of blocks.

The capturing information indicates information such as captured time and date information indicating time/date when a video included in the blocks was captured, captured location information indicating a location where the video included in the blocks was captured by latitude and longitude, and captured person information indicating a person who is on the video included in the blocks.

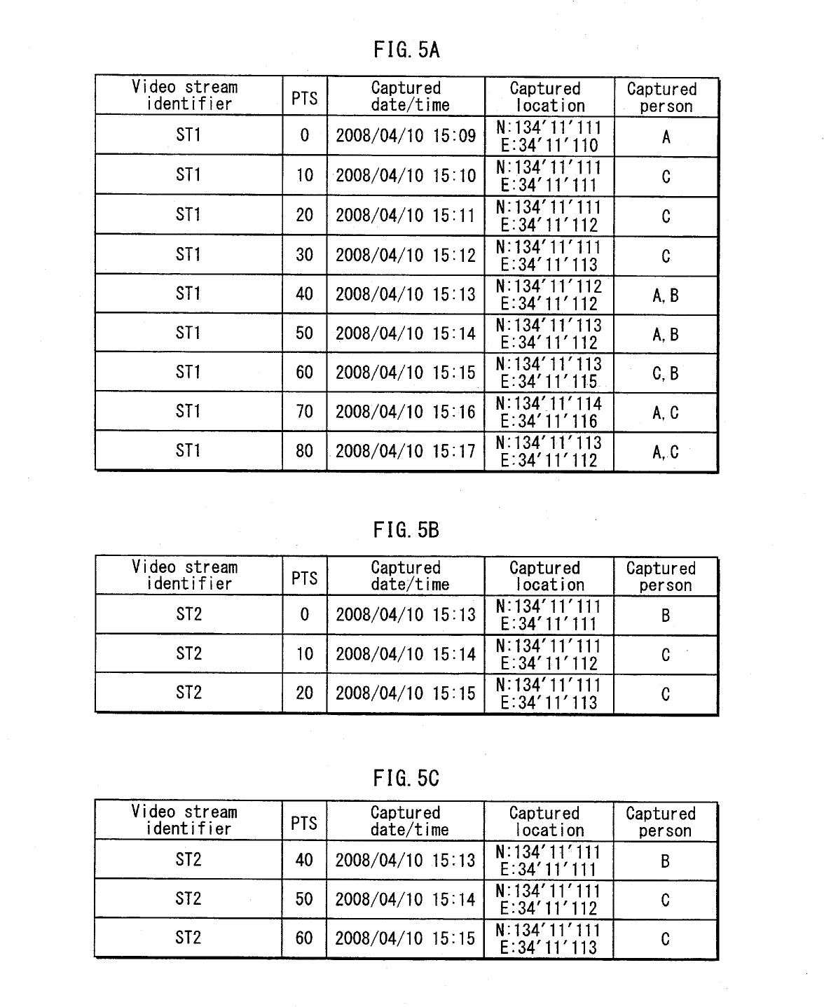

FIGS. 5A and 5B show respective examples of video information M1 related to the video stream ST1 and video information M2 related to the video stream ST2.

As FIG. 5A shows, the video information M1 is a table that relates the nine blocks of the video stream ST1 to respective video stream identifiers, respective PTSs and respective pieces of the capturing information.

As FIG. 5B shows, the video information M2 is a table that relates the three blocks of the video stream ST2 to respective video stream identifiers, respective PTSs and respective pieces of the capturing information.

The video information is created at the same time when the video stream is stored while a video is being captured. That is, captured time and date information is acquired by a clock, captured location information is acquired by GPS (Global Positioning System), and captured person information is acquired by a face recognition function. However, in order to acquire the captured person information by the face recognition function, it is necessary to register beforehand in database, a relation between data and a name of a captured person for face recognition.

### <Comparison Reference Information>

The comparison reference information indicates which element is used as a comparison reference so as to create multi-angle video data for multi-angle playback among a plurality of pieces of capturing information included in each entry of the video information. That is, the comparison reference information indicates any one of, or combination of captured time and date information, captured location information and captured person information. In the following explanation, an element indicated by the comparison reference information is only captured time and date information.

### <Operation>

The following explains an overview of a creating operation of multi-angle video data for multi-angle playback, which is performed by the video data creating apparatus 100.

When acquiring the video data 1, the video data 2 and the comparison reference information, the video data creating apparatus 100 compares the video information M2 included in the video data 2 with the video information M1 included in the video data 1. The video data creating apparatus 100 then detects a set of blocks among the video data 1 and the video data 2, which matches in elements included in the capturing information and indicated by the comparison reference information. When the set of blocks is detected, the video data creating apparatus 100 modifies the video information M2 and PTSs of the video stream ST2, such that PTSs of the blocks included in the detected set of blocks match. Next, the video data creating apparatus 100 creates playback path information based on the video information M1, the related video stream ST1, the modified video information M2 and the related video stream ST2. The video data 3 to be created, which is multi-angle video data for multi-angle playback, is composed of (i) the playback path information created by the video data creating apparatus 100 in this way, (ii) the video information M1, (iii) the video stream ST1, (iv) the modified video information M2 and (v) the video stream ST2.

The term “compare” means comparing an element of a piece of capturing information with an element of another piece of capturing information and judging whether the two elements match. The term “match” means that the two elements have the same value or a similar value and are within an acceptable range. The acceptable range has been set depending on accuracy with which the capturing information has been stored while a video is being captured. For example, in an example of FIGS. 5A-C, captured time and date information is stored in units of minutes and it is therefore impossible to distinguish time difference of below one minute. Accordingly, in comparison, if time difference is below one minute, it is judged that the compared pieces of captured time and date information match. Also, captured location information is stored in units of 0′0′001, and it is therefore impossible to distinguish location difference of below 0′0′001. Accordingly, in comparison, if location difference is below 0′0′001, it is judged that the compared pieces of captured location information match. With regard to captured person information, when names of captured people match the registered name, it is judged that compared pieces of captured person information match.

Specifically, the following explains an example in which the video information M2 shown in FIG. 5B is compared with the video information M1 shown in FIG. 5A, and a set of blocks is detected. The set of blocks match in an element included in the capturing information and indicated by the comparison reference information, that is, captured time and date information. It is understood that entries from PTSs 40 to 60 of the video information M1 shown in FIG. 5A match respective entries from PTSs 0 to 20 of the video information M2 shown in FIG. 5B in captured time and date information. When blocks that match in captured time and date information are detected, each PTS of the detected entries included in the video information M2 is modified to match the PTS of the corresponding entry included in the video information M1. As a result, the modified video information M2 is as shown in FIG. 5C. In accordance with the PTSs of the modified video information M2, the video data creating apparatus 100 modifies the PTSs of the video stream ST2 related to the video information M2.

Next, the video data creating apparatus 100 creates playback path information of the video data 3.

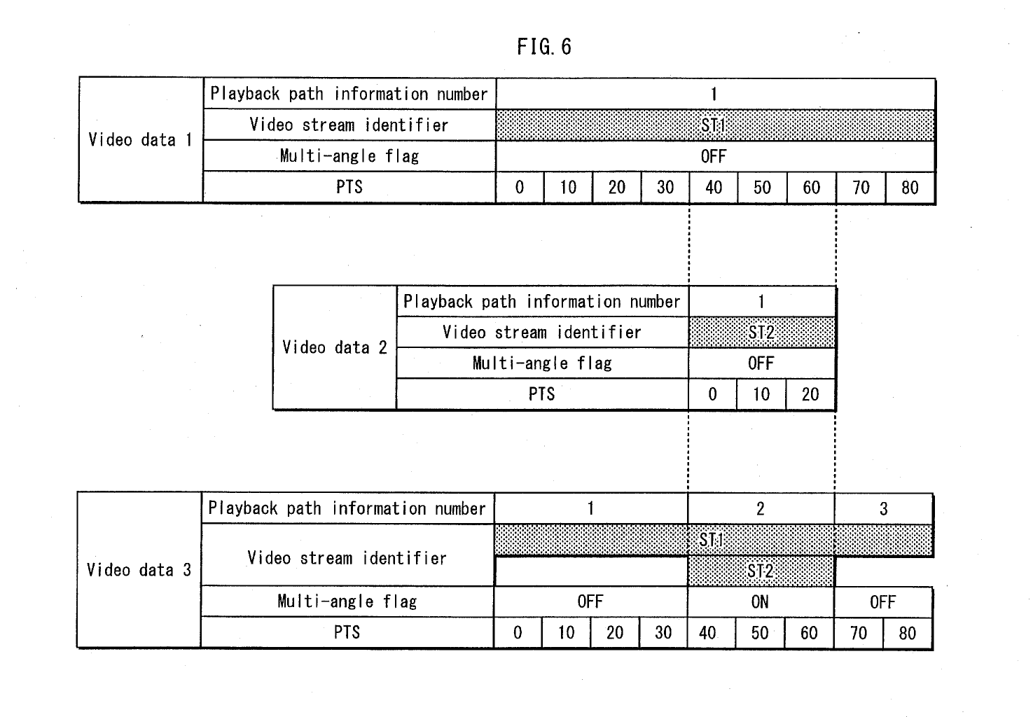

FIG. 6 shows how the playback path information of the video data 3 is created.

FIG. 6 shows as follows. The blocks including the PTSs 40 to 60 of the video information M1 match blocks including the PTSs 0 to 20 of the video information M2 in time and date information. The video stream ST2 that includes blocks including the PTSs 0 to 20 of the video stream ST2 related to the video information M2 is modified in accordance with blocks including the PTSs 40 to 60 included in the video stream ST1 related to the video information M1. Accordingly the video data 3 includes the video stream ST1 related to the video information M1 and the modified video stream ST2.

When the video data creating apparatus 100 plays back blocks indicated by the PTSs in order and a set of the video streams to be played back is not changed, the playback path is indicated by the same playback path information. Each time a set of video stream to be played back is changed, playback path information of the video data 3 is created so as to indicate a different playback path.

That is, in a case shown in FIG. 6, a video stream to be played back in a range from the PTSs 0 to 30 is only the video stream ST1. Accordingly, the video data creating apparatus 100 creates playback path information indicating that the playback beginning PTS is 0, the playback end PTS is 30, and the video stream identifier indicating a video stream to be played back is ST1, and sets the multi-angle flag to be OFF. Such playback path information is assigned the playback path information number 1.

In a range from the PTSs 40 to 60, two video streams ST1 and ST2 are to be played back. Accordingly, the video data creating apparatus 100 creates playback path information indicating that the playback beginning PTS is 40, the playback end PTS is 60, and the video stream identifiers indicating video streams to be played back are ST1 and ST2, and sets the multi-angle flag to be ON. Such playback path information is assigned the playback path information number 2.

Furthermore, in a range from the PTSs 70 to 80, the video stream to be played back is only the video stream ST1. Accordingly, the video data creating apparatus 100 creates playback path information indicating the playback beginning PTS is 70, the playback end PTS is 80, and the video stream identifier indicating a video stream to be played back is ST1, and sets the multi-angle flag to be OFF. Such playback path information is assigned the playback path information number 3.

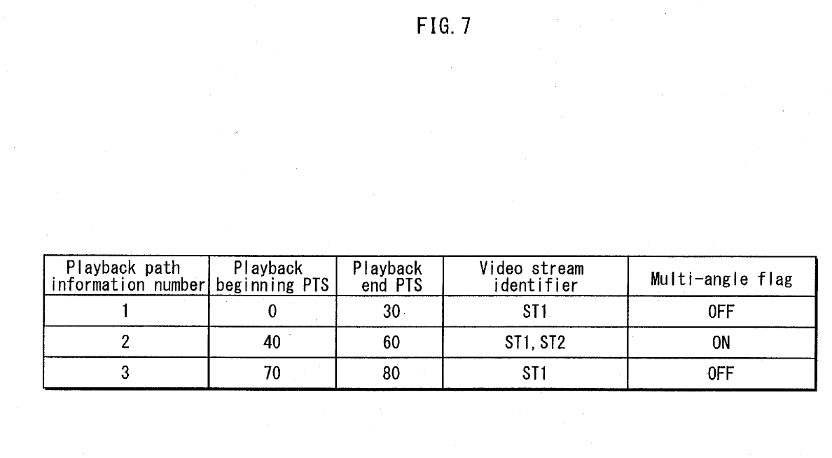

The playback path information of video data 3 created as above is as shown in FIG. 7.

### <Video Data Creating Process>

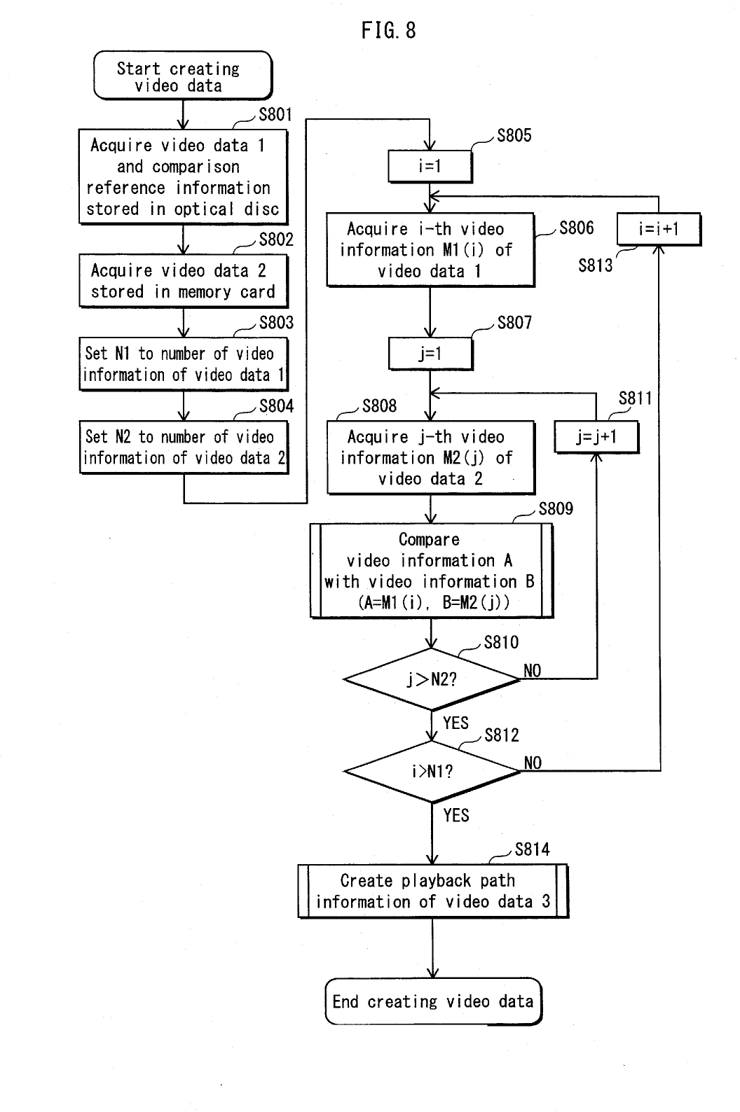

The following explains a video data creating process performed by the video data creating apparatus 100, using a flowchart shown in FIG. 8.

First, the acquisition unit 101 acquires video data 1 and the comparison reference information each stored in the optical disc 160 (S801). The acquisition unit 101 then acquires the video data 2 stored in the memory card 170 (S802).

The creating unit 102 counts the number of pieces of the video information included in the video data 1 that has been acquired by the acquisition unit 101. The creating unit 102 then assigns the number to a variable N1 (S803). The variable Ni is for storing therein the number of pieces of the video information included in the video data 1. Next, the creating unit 102 counts the number of pieces of the video information included in the video data 2 that has been acquired by the acquisition unit 101. The creating unit 102 then assigns the number to a variable N2 (S804). The variable N2 is for storing the number of pieces of the video information included in the video data 2.

Next, a variable i is initialized to be one (S805). While the variable i is incremented by one (S813) until the variable i is N1 (S812), video information M1 (i) is acquired (S806) and the following process is repeated. The video information M1(i) is the i-th piece of video information of the video data 1.

The variable j is initialized to be one (S807). While the variable j is incremented by one (S811) until the variable j is N2 (S810), video information M2(j) is acquired (S808) and the following process is repeated. The video information M2(j) is the j-th piece of video information of the video data 2.

A comparison process of video information A with video information B is repeated (S809). Here, the video information A is the video information M1(i), and the video information B is the video information M2(j).

When the above repetitive process ends, a creating process of playback path information of the video data 3 is performed (S814).

As described above, the video data 3 is created.

### <Comparison Process>

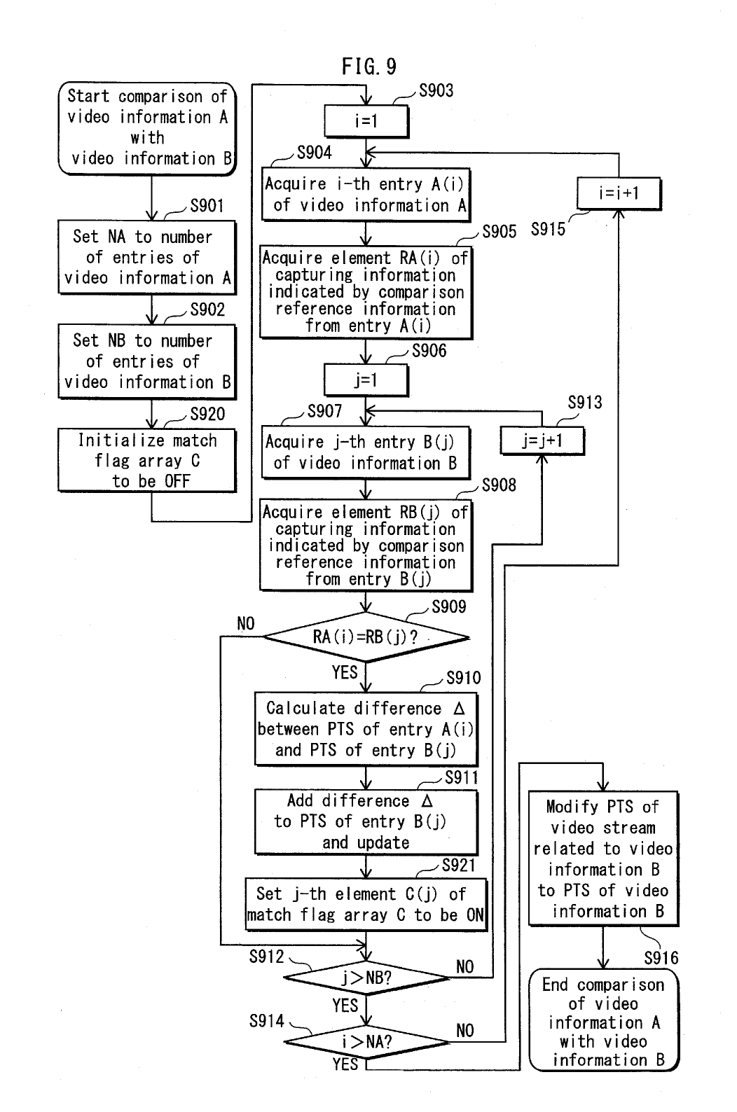

The following is an explanation of a comparison process of the video information A with the video information B, using a flowchart shown in FIG. 9.

First, a number of entries of the video information A is counted, and the number is assigned to a variable NA (S901). The variable NA is for storing the number of entries of the video information A. Next, a number of entries of the video information B is counted, and the number is assigned to a variable NB (S902). The variable NB is for storing the number of entries of the video information B.

All elements of a match flag array C that includes NB elements are initialized to be OFF (S920).

A variable i is initialized to be one (S903). The following process is repeated while the variable i is incremented by one (S915) until the variable i is NA (S914).

An entry A(i) is acquired (S904). The entry A(i) is the i-th entry of the video information A. Next, an element RA(i) that is included in the capturing information and indicated by the comparison reference information is acquired from the entry A(i) (S905).

The variable j is initialized to be one (S906). The following process is repeated while the variable j is incremented by one (S913) until the variable j is NB (S912).

An entry B(j) is acquired (S907). The entry B(j) is the j-th entry of the video information B. Next, an element RB(j) that is included in the capturing information and indicated by the comparison reference information is acquired from the entry B(j) (S908).

The elements RA(i) and RB(j) of the capturing information are compared (S909).

When the elements RA(i) and RB(j) of the capturing information match (S909: Y), a difference A between a PTS of the entry A(i) and a PTS of the entry B(j) is calculated (S910). After the difference A is added to the PTS of the entry B(j) and update is performed (S911), the j-th element C(j) of the match flag array C is set to be ON (S921).

When the above repetitive process ends, a PTS of a video stream related to the video information B is modified in accordance with the PTS of the video information B (S916).

As described above, the comparison process of the video information A with the video information B is completed.

### <Playback Path Information Creating Process>

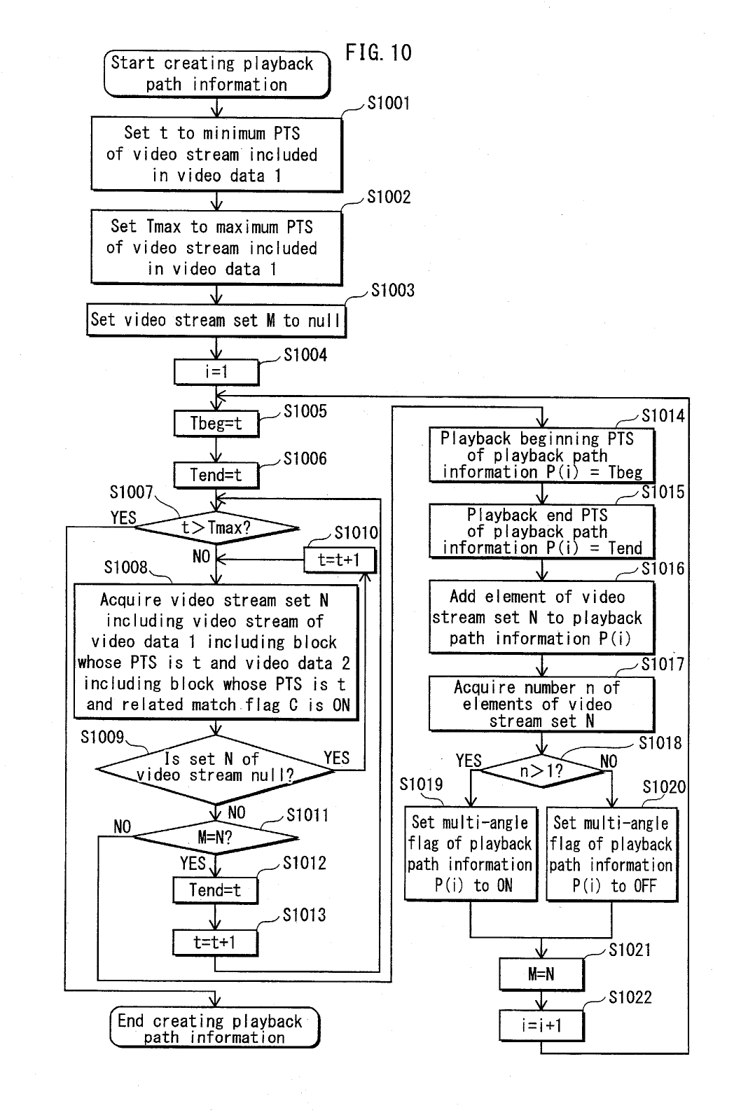

The following describes a playback path information creating process of the video data 3, using a flowchart shown in FIG. 10.

A minimum PTS of the video stream included in the video data 1 is assigned to a variable t (S1001). Next, a maximum PTS of the video stream included in the video data 1 is assigned to a variable Tmax (S1002).

A video stream set M is set to be null (S1003).

The variable i is initialized to be one (S1004).While the variable i is incremented by one (S1022), the following process is repeated.

The variable t is assigned to a variable Tbeg (S1005). Next, the variable t is assigned to a variable Tend (S1006).

The following process is repeated until the variable t exceeds the variable Tmax (S1007).

First, a video stream set N is acquired. The video stream set N includes the video stream of the video data 1 including a block of whose PTS is t and the video data 2 including a block whose PTS is t and a match flag C related to the block is ON (S1008).

If the video stream set N is null (S1009: Y), the variable t is incremented by one (S1010), and the process is repeated until the video stream set N is not null.

If the video stream set N that is not null is detected (S1009: N), a previous video stream set M is compared with the video stream set N (S1011).

If the video stream sets M and N match (S1011: Y), the variable Tend is updated to be the variable t (S1012) and the variable t is incremented by one (S1013). With regard to the incremented variable t, the above process is repeated.

If the video stream sets M and N do not match (S1011: N), a playback beginning PTS of the i-th piece of playback path information P(i) is set to be Tbeg (S1014) and a playback end PTS of the i-th piece of playback path information P(i) is set to be Tend (S1015). Furthermore, an element of the video stream set N is added to the playback path information P(i) (S1016).

Next, a number n of elements of the video stream set N is acquired (S1017). If the number n of the elements is more than one (S1018: Y), a multi-angle flag of the playback path information P(i) is set to be ON (S1019). If the number n of the elements is not more than one (S1018: N), the multi-angle flag of the playback path information P(i) is set to be OFF (S1020).

As described above, creating of the i-th piece of playback path information is completed.

Next, the video stream set M is set to be the video stream set N (S1021), and the playback path information number I is incremented by one (S1022). Then next piece of playback path information is created.

When the variable t exceeds the variable Tmax, the playback path information creating process ends.

### <Specific Example>

A person overwrites the optical disc 160 with the multi-angle video data for multi-angle playback that has been created based on the video data 1, as described above, and hands the optical disc to another person. Then the another person who has received the optical disc 160 can create multi-angle video data for multi-angle playback based on video data captured by a number of people, as follows. The another person creates the multi-angle video data by appending video data captured by him/her to the video data stored in the optical disc 160 based on the comparison reference information stored in the optical disc. The another person then overwrites the optical disc with the created video data and hands the optical disc to next person.

### <Playback Operation>

The following explains how a playback apparatus plays back the multi-angle video data for multi-angle playback created by the video data creating apparatus 100.

A playback apparatus plays back video data in order of playback path information number, based on playback path information included in the video data. During the playback based on the playback path information, a video stream indicated by the playback path information is played back from a playback beginning PTS to a playback end PTS. When a multi-angle flag included in the playback path information is ON, the playback path information indicates two or more video streams and one of the two or more video streams is played back. On receipt of an operation such as a button operation of a remote controller by a user, the video streams are switched and another video stream is played back.

### Second Embodiment

The embodiment 1 has explained the video data creating apparatus that creates multi-angle video data for multi-angle playback based on the two or more video streams included in the two pieces of video data. The present embodiment explains a video data creating apparatus that creates multi-angle video data for multi-angle playback based on a video stream included in video data and image data.

This realizes by creating, from image data, an image stream that displays slide show of the image data in order of captured time and date, and creating multi-angle video data for multi-angle playback in accordance with the created image stream, in the same way used by the video data creating apparatus pertaining to the embodiment 1. Accordingly, in the first embodiment, the video data 2 acquired by the acquisition unit 101 is output to the creating unit 102. On the other hand, in the present embodiment, image data acquired by the acquisition unit 101 is output to an image stream creating unit 106, and the image stream creating unit 106 outputs an image stream created by the image stream creating unit 106 and video information of the created image stream to the creating unit 102.

### <Structure>

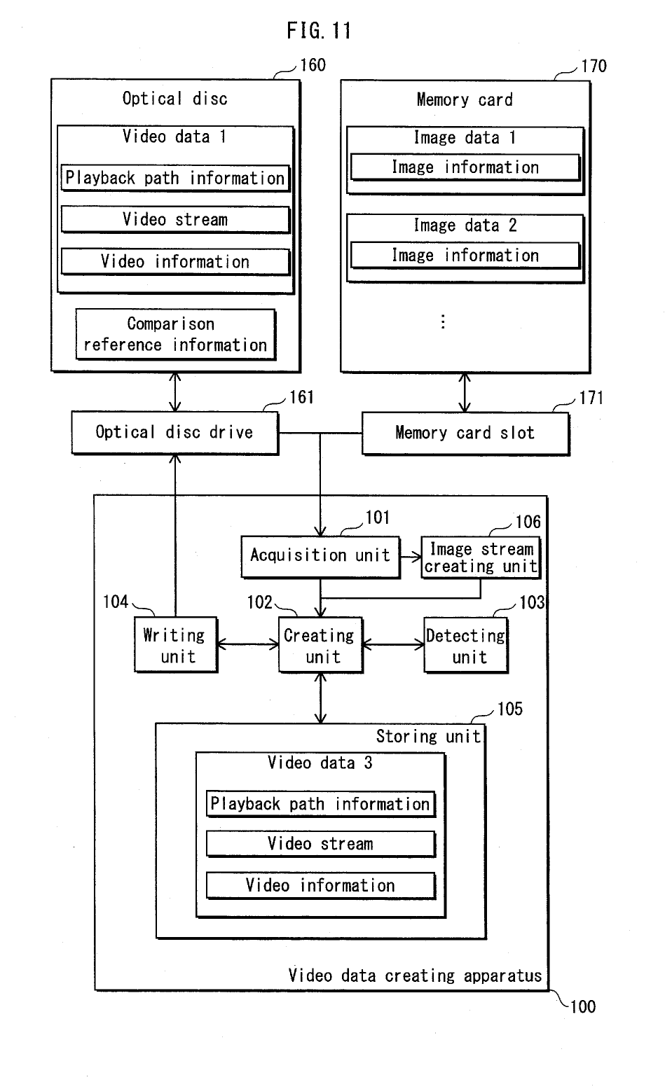

The following explains a structure of the video data creating apparatus pertaining to the present embodiment, using FIG. 11.

A video data creating apparatus 100 pertaining to the present embodiment acquires video data 1 and comparison reference information each stored in an optical disc 160 by an optical disc drive 161 and image data stored in a memory card 170 by a memory card slot 171, so as to create video data 3. Also, the video data creating apparatus 100 overwrites the optical disc 160 with the created video data 3 by the optical disc drive 161.

The video data creating apparatus 100 of the present embodiment has the same structure of the video data creating apparatus 100 of the first embodiment, except that the image stream creating unit 106 is added.

The image stream creating unit 106 detects from the image data acquired by the acquisition unit 101, a piece of image data whose element indicated by the comparison reference information matches an element indicated by the comparison reference information of blocks that constitute the video stream included in the video data 1. The image stream creating unit 106 creates an image stream for displaying slide show of the detected piece of image data, and creates video information of the created image stream.

After the image stream creating unit 106 created the image stream and video information of the created image stream, a subsequent process is the same process as performed in the first embodiment. That is, the creating unit 102 creates multi-angle video data for multi-angle playback, based on (i) the video data 1 and (ii) the image stream and the video information each created by the image stream creating unit 106.

### <Image Data>

The following explains a structure of image data from which an image stream is to be created by the image stream creating unit 106.

The image data includes data per se, such as data of captured photographs, and image information that has been added to the data.

The image information indicates information such as captured time and date information, captured location information and captured person information of captured image data. The image information is created at a time of capturing the image, and related to each piece of the image data in compliance with Exif standard. According to the Exif standard, information such as resolution of the image, compression format, a type of a camera that captured the image data, settings of the camera at the time of capturing the image, and captured time and date information is tagged and stored in a single file along with the image data. Accordingly, it is easy to relate information such as captured location information and captured person information to the image data and store these pieces of information in the single file.

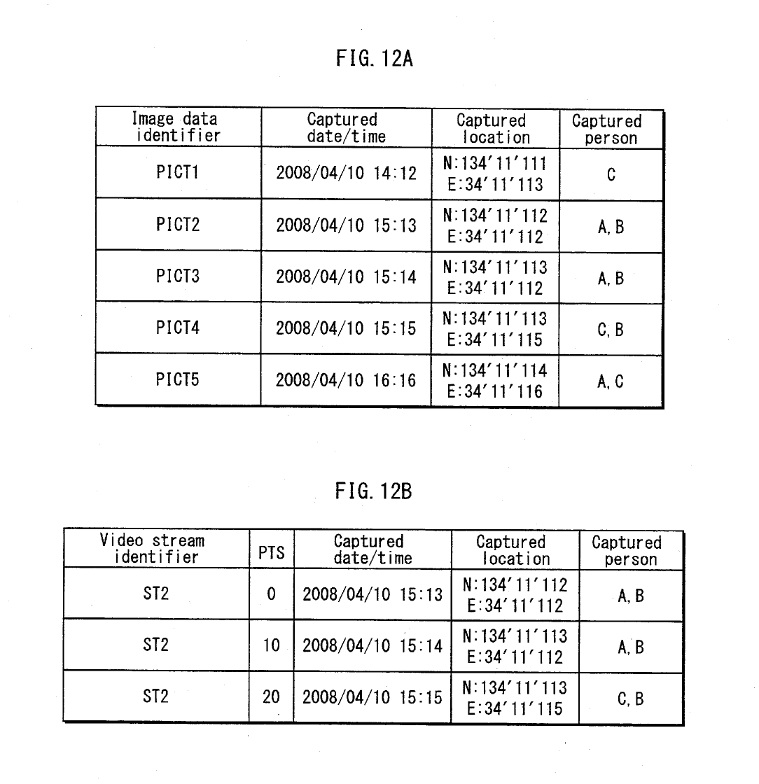

FIG. 12A shows an example of the image information included in the image data. Here, five pieces of image data are stored in the memory card 170, and image data identifiers that identify respective pieces of the image data are PICT 1 to PICT 5.

Now, an element indicated by the comparison reference information is assumed to be captured time and date. When the image information shown in FIG. 12A is compared with the video information M1 included in the video data 1 shown in FIG. 5A, entries including PTSs 40 to 60 of the video information M1 matches the three pieces of image information including the PICT 2 to PICT 4 in captured time and date. Accordingly, the image stream creating unit 106 creates an image stream ST2 including capturing information shown in FIG. 12B.

### <Image Stream Creating Process>

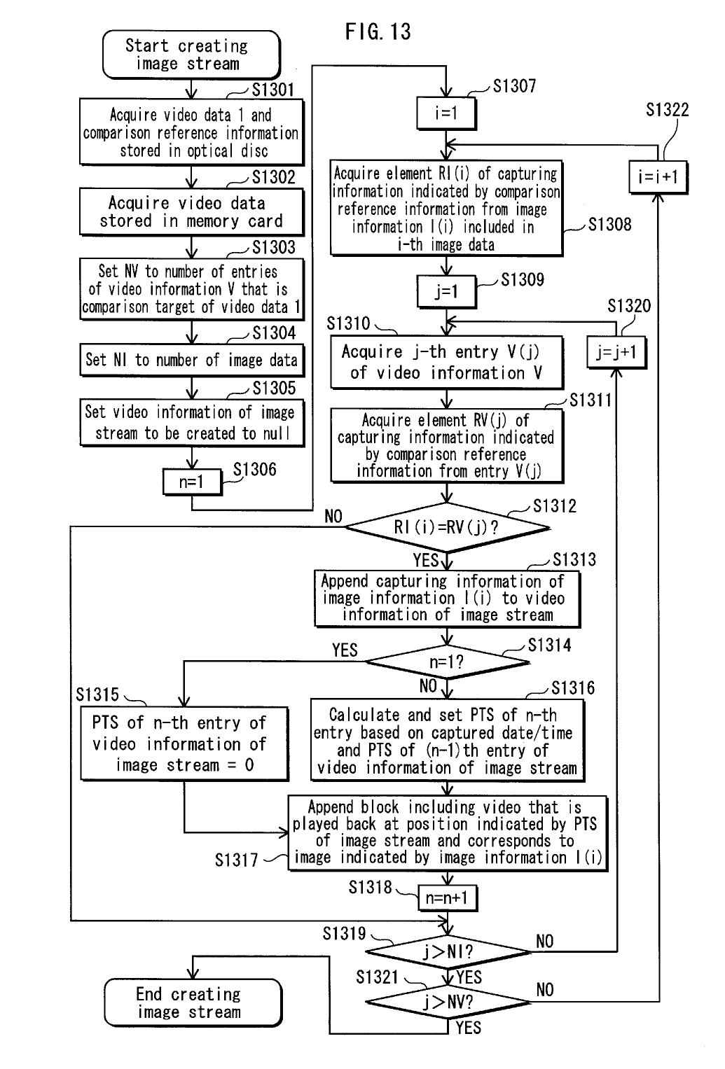

The following explains an image stream creating process, using FIG. 13. When an image stream is created, video information of the image stream is also created.

First, the video data 1 and the comparison reference information each stored in the optical disc 160 are acquired (S1301). Next, the image data stored in the memory card 170 is acquired (S1302).

A variable NV is set to be a number of entries of video information V that is comparison target and included in the video data 1 (S1303). A variable NI is set to be the number of pieces of image data (S1304).

The video information of the image stream is set to be null (S1305). A variable n is initialized to be one (S1306). The variable n indicates which entry of the video information of the image stream is being created.

A variable i is initialized to be one (S1307). The following process is repeated while the variable i is incremented by one (S1322) until the variable i is NV (S1321).

First, an element RI(i) included in the capturing information and indicated by the comparison reference information is acquired from image information I(i) included in the i-th image data (S1308).

The variable j is initialized to be one (S1309). The following process is repeated while the variable j is incremented by one (S1320) until the variable j is NI (S1319).

An entry V(j) that is the j-th entry of the video information V is acquired (S1310). Next, an element RV(j) included in the capturing information and indicated by the comparison reference information is acquired from the entry V(j) (S1311).

The elements RI(i) and RV(j) of the capturing information are compared (S1312).

If the element RI(i) and RV(j) of the capturing information match (S1312: Y), the capturing information of the image information I(i) is added to the video information of the image stream (S1313).

If the variable n is one (S1314: Y), that is, the first entry of the video information of the image stream is being processed, a PTS of the entry is set to be zero (S1315).

If the variable n is not one (S1314: N), based on captured time and date and a PTS of (n-1)th entry of the video information of the image stream, a PTS of the n-th entry is calculated, and the calculated PTS is set to be the PTS of the n-th entry (S1316). Here, the PTS is calculated as follows. For example, as shown in the video information M1 of FIG. 5A, the PTS increases by 10 per minute. Accordingly, based on the above relationship, the PTS of the first entry that is 0, and a difference of captured time and date of the (n-1)th entry, a PTS of the n-th entry can be calculated.

When the PTS of the entry of the video information of the image stream is set, a block including an image corresponding to the image information I(i) is added to the image stream at a position indicated by the same PTS (S1317). Thus, while the block is being played back, the image corresponding to the image information I(i) can be displayed as multi-angle video.

The above process is repeated while the variable n is incremented by one (S1318), and the image stream and the video information of the image stream are created. The variable n indicates an entry of the image information, which is being processed.

The image stream and the video stream of the image stream are created as described above. It is then possible to create multi-angle video data for multi-angle playback by applying the created image stream and the video information of the image stream, instead of the video stream and the video information each included in the video data 2 pertaining to the embodiment 1.

### <<Supplement>>

The above embodiment may be modified as below.

(1) According to the above embodiments, the captured time and date is used as the element indicated by the comparison reference information. However, the present invention is not necessarily limited to this. The element indicated by the comparison reference information has only to be information indicating contents of a block included in a video stream. The element is not limited to the captured time and date but may be captured location or captured person. In the above embodiments, this can be realized by not acquiring the captured time and date from the video information but acquiring the element that is included in the capturing information and indicated by the comparison reference information. However, the capturing information needs to be created beforehand. If the element that is included in the capturing information and indicated by the comparison reference information is captured location, the captured location is acquired by GPS, and if the element is captured person, the captured person is acquired by a face recognition function.

(2) According to the above embodiments, the element indicated by the comparison reference information is only the captured time and date. However, the present invention is not necessarily limited to this. The comparison reference information may indicate more than one element included in the capturing information. In this case, in comparison of blocks described in the above embodiments, comparison is performed with regard to all of the more than one element indicated by the comparison reference information. When all of the compared elements match, it is judged that respective blocks match. Here, in the case where elements indicated by the comparison reference information are the captured time and date and the captured location, comparing all of the more than one element means judging whether blocks match in both of the captured time and date and the captured location.

Also, if the elements indicated by the comparison reference information include the captured time and date, the captured time and date may be compared preferentially. That is, when detecting a set of blocks that matches based on the two pieces of video information, a set of blocks that matches in the captured time and date is detected first. Then, with regard to the detected set of blocks, it is judged whether the elements indicated by the comparison reference information other than the captured time and date match. Thus, by comparing the captured time and date preferentially, it is possible to create multi-angle video in proper sense of the term, which means combining pieces of video data captured at the same time from different angles.

(3) According to the above embodiments, the person acquires video data captured by the other people by receiving the optical disc 160 in which the video data is stored. However, the present invention is not necessarily limited to this. The optical disc 160 may not be handed, and other recording medium may be handed. The optical disc may be passed by a method such as mailing. Also, video data captured by video capturing function of an apparatus such as a digital still camera and a mobile phone may be transmitted/received via network, and multi-angle video data for multi-angle playback may be created based on the transmitted/received video data.

(4) According to the above embodiments, the video data 1 is stored in the optical disc 160 and the video data 2 is stored in the memory card 170. However, the present invention is not necessarily limited to this. A recording medium in which the video data 1 is stored has only to be readable by the video data creating apparatus 100 and portable, as long as the video data is not transmitted/received via network as described above. A recording medium in which the video data 2 is stored has only to be readable by the video data creating apparatus 100.

(5) According to the above embodiment, the optical disc 160 is overwritten with the video data 3 created by the video data creating apparatus 100. However, the present invention is not necessarily limited to this. The video data 3 may be stored in a recording medium that is different from a recording medium in which the video data 1 is stored, and handed repeatedly.

(6) According to the above embodiment, when it is judged whether the elements included in the capturing information match in a comparison process, an acceptable range is set depending on accuracy with which the capturing information has been stored while a video is being captured. However, the present invention is not necessarily limited to this. That is, an acceptable range may be less accurate than the accuracy with which the capturing information was stored. For example, when the captured time and date is stored in units of minutes, a difference below five minutes may be judged as a match.

### INDUSTRIAL APPLICABILITY

A video data creating apparatus of the present invention can be used in apparatuses that store video data in a recording medium, such as a personal computer, a DVD recorder, a DB recorder and a digital video camera. Also, the video data creating apparatus of the present invention can be used in an apparatuses such as a digital still camera and a mobile phone, which can capture video data and is communicable with an external device, when video data is stored in a recording medium via the external device.

### REFERENCE SIGNS LIST

100 video data creating apparatus

101 acquisition unit

102 creating unit

103 detecting unit

104 writing unit

105 storing unit

106 video stream creating unit

160 optical disc

161 optical disc drive

170 memory card

171 memory card slot

1-12. (canceled)

13. A video data creating apparatus comprising:
a storing unit that stores therein first video data;
an acquisition unit operable to acquire second video data stored in a recording medium;
a detecting unit operable to detect a section that is to be a multi-angle playback section from each of the first video data and the second video data, the sections matching in at least one of elements of captured time and date, captured location and captured person;
a creating unit operable to create multi-angle data for multi-angle playback in the detected section of the second video data, based on the second video data and the detected sections; and
a writing unit operable to write the created multi-angle data to the recording medium, wherein
the recording medium is a portable recording medium.

14. The video data creating apparatus of claim 13, wherein
the detected sections of the first video data and the second video data match in at least the captured time and date and the captured location.

15. The video data creating apparatus of claim 13, wherein
the acquisition unit acquires comparison reference information stored in the recording medium, the comparison reference information indicating the at least one element, and
the detected sections of the first video data and the second video data match in the at least one element indicated by the comparison reference information.

16. A method for creating video data comprising the steps of:
storing therein first video data;
acquiring second video data stored in a recording medium;
detecting a section that is to be a multi-angle playback section from each of the first video data and the second video data, the sections matching in at least one of elements of captured time and date, captured location and captured person;
creating multi-angle data for multi-angle playback in the detected section of the second video data, based on the second video data and the detected sections; and
writing the created multi-angle data to the recording medium, wherein the recording medium is a portable recording medium.
